(19) United States
(12) Patent Application Publication
(10) Pub. No.: US 2015/0265917 A1
(43) Pub. Date: Sep. 24, 2015

(54) GAME APPARATUS

(71) Applicants: Chia-Han Chang, New Taipei City (TW); Chia-Hung Huang, Taoyuan County (TW); Mark Junren Wiener, Houston, TX (US)

(72) Inventors: Chia-Han Chang, New Taipei City (TW); Chia-Hung Huang, Taoyuan County (TW); Mark Junren Wiener, Houston, TX (US)

(73) Assignee: Chia-Han Chang, New Taipei City (TW)

(21) Appl. No.: 14/220,150

(22) Filed: Mar. 20, 2014

(51) Int. Cl. A63F 13/31; A63F 13/215; A63F 13/213; A63F 13/212; A63F 13/217

(52) U.S. Cl. CPC A63F 13/31; A63F 13/212; A63F 13/217; A63F 13/213; A63F 13/215

(57) ABSTRACT

A game apparatus having an attack apparatus, a wearable apparatus and a communication apparatus is provided. The communication apparatus determines a property of the attack apparatus according to an attack signal sensed by the wearable apparatus and adjusts a status prompt signal emitted by the wearable apparatus according to the property of the attack apparatus.

### BACKGROUND OF THE INVENTION

1. Field of the Invention

The invention relates to an electronic apparatus, and more particularly, to a game apparatus.

2. Description of Related Art

In recent years, war games have become an unmistakable trend all around the world. War games are a combat simulation game with diverse gameplay that can be played in a variety of locations, and specific game rules for war games may not be the same to one another. Generally, players are divided into two or more groups of people for simulated combat, and victory is achieved by eliminating the players in enemy groups. During the game, the players may use authorized non-lethal projectile launchers to fire projectiles simulating bullets at members of the opposing team. Then, whether a player being shot is eliminated is determined by the specific game rules such as what part of the body has been shot or counting a number of times that the player is shot. Because victory or defeat, or life and death are decided based on free proof rule in conventional gameplay of war games, there is a lack of fairness due to the rules being applied subjectively.

### SUMMARY OF THE INVENTION

The invention is directed a game apparatus capable of improving of fairness and fun of war game.

A game apparatus of the invention includes an attack apparatus, a wearable apparatus and a communication apparatus. The wearable apparatus is used for sensing an attack signal of the attack apparatus. The communication apparatus is used for communicating with the wearable apparatus, determining a property of the attack apparatus according to the attack signal sensed by the wearable apparatus, and adjusting a status prompt signal emitted by the wearable apparatus according to the property of the attack apparatus. The status prompt signal prompts a status of the wearable apparatus.

In an embodiment of the invention, the communication apparatus further displays the status and a property of the wearable apparatus and a status and the property of the attack apparatus.

In an embodiment of the invention, the property of the wearable apparatus includes a defense of the wearable apparatus, a team name and a profession that the wearable apparatus belongs to; the property of the attack apparatus includes a type of the attack apparatus and a damage possibly dealt by the attack apparatus; the status of the wearable apparatus includes a hit point of the wearable apparatus; and the status of the attack apparatus includes a usage status of the attack apparatus.

In an embodiment of the invention, a different profession of the wearable apparatus is correspondingly paired with a different type of the attack apparatus, the communication apparatus further determines whether the attack apparatus is an apparatus paired with the wearable apparatus according to the attack signal, and the communication apparatus does not adjust the status prompt signal emitted by the wearable apparatus according to the attack apparatus if the attack apparatus is the apparatus paired with the wearable apparatus.

In an embodiment of the invention, the wearable apparatus includes a sensing unit, a communication unit, a status prompt unit and a control unit. The sensing unit senses the attack signal. The status prompt unit is used for emitting the status prompt signal. The control unit is coupled to the sensing unit, the communication unit and the status prompt unit, and controlling the communication unit to transmit the attack signal sensed by the sensing unit to the communication apparatus. The communication unit determines the property of the attack apparatus according to the attack signal and transmits a control signal to the communication unit according to the property of the attack apparatus for the control unit to adjust the status prompt signal emitted by the status prompt unit according to the control signal.

In an embodiment of the invention, the attack apparatus includes an electronic tag, and the sensing unit includes an electronic tag reader.

In an embodiment of the invention, the attack apparatus is a bullet having an accommodating space for accommodating the electronic tag, and the electronic tag includes a housing, a chip, an elastic object and an antenna. A disposing direction of the chip, the elastic object and the antenna in the housing is parallel to a flying direction of the bullet. The elastic object is disposed between the chip and the antenna, and the accommodating space in the housing has a length parallel to the flying direction of the bullet which is longer than a total length of the chip, the elastic object and the antenna.

In an embodiment of the present invention, the attack apparatus includes a signal emitting unit and emitting control unit. The emitting control unit is coupled to the signal emitting unit. The emitting control unit is used for receiving an activating signal for controlling the signal emitting unit to emit the attack signal.

In an embodiment of the invention, the wearable apparatus further includes an activating unit coupled to the control unit, and emitting the activating signal under control of the control unit.

In an embodiment of the invention, the signal emitting unit and the activating unit are active electronic tags, and the sensing unit and the emitting control unit are electronic tag readers.

In an embodiment of the invention, the game apparatus further includes a counter coupled to the emitting control unit, and configured to count time. The emitting control unit controls the signal emitting unit to emit the attack signal after the activating signal is received for passing a predetermined time. The counter may be disposed inside the emitting control unit, or outside the emitting control unit.

In an embodiment of the invention, the status prompt signal includes one of a sound signal and an optical signal, or a combination thereof.

In an embodiment of the invention, the communication apparatus includes a smart phone or a tablet computer.

In an embodiment of the invention, the communication apparatus further includes a global positioning system function for positioning a location of the wearable apparatus or the communication apparatus of other players.

Based on above, the communication apparatus according to the embodiments of the invention may determine the property of the attack apparatus according to the attack signal sensed by the wearable apparatus, and adjust the status prompt signal emitted by the wearable apparatus according to the property of the attack apparatus, and the status prompt signal prompts the status of the wearable apparatus. Based on the status prompt signal emitted by the wearable apparatus, the player may learn whether other players are of the enemy or the teammate as well as the hit points of the enemy players or the teammates by a quick look, so as to improve fairness of gameplay while enriching variability of gameplay.

To make the above features and advantages of the disclosure more comprehensible, several embodiments accompanied with drawings are described in detail as follows.

### BRIEF DESCRIPTION OF THE DRAWINGS

FIG. 1 is a schematic view of a game apparatus according to an embodiment of the invention.

FIG. 2 is a schematic view of a game apparatus according to another embodiment of the invention.

FIG. 3A is a cross-sectional view of an attack apparatus according to an embodiment of the invention.

FIG. 3B is a schematic view of the electronic tag of the embodiment of FIG. 3A.

FIG. 4 is a schematic view of a game apparatus according to another embodiment of the invention.

FIG. 5 is a schematic view of a game apparatus according to another embodiment of the invention.

### DESCRIPTION OF THE EMBODIMENTS

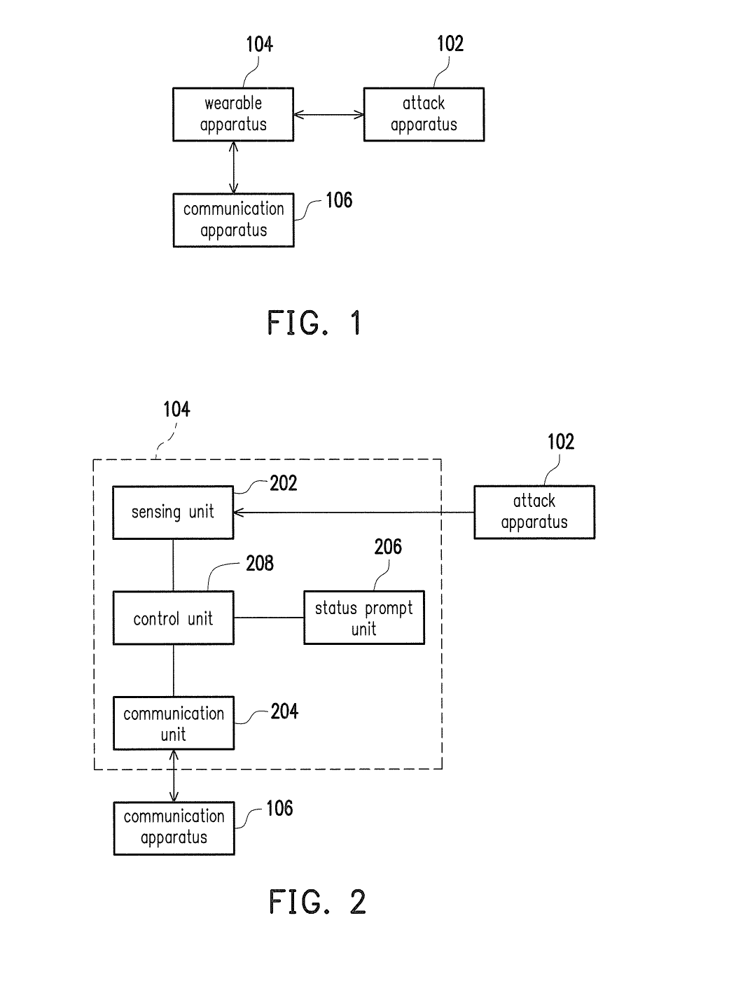

FIG. 1 is a schematic view of a game apparatus according to an embodiment of the invention. Referring to FIG. 1, the game apparatus may include an attack apparatus 102, a wearable apparatus 104 and a communication apparatus 106. The attack apparatus 102 may be, for example, a bullet or an explosive apparatus. The wearable apparatus 104 may be in forms of, for example, a vest, a jacket, a backpack or a helmet. The communication apparatus 106 may be, for example, a smart phone, a tablet computer or portable electronic apparatuses in other types. In addition, the communication apparatus 106 may be, for example, disposed on the wearable apparatus 104 (e.g., fixed inside a pocket of the vest or the jacket), or may be fixed on a player by using a clipping tool (e.g., fixed on arms and legs of the player through an armband). In some embodiments, the communication apparatus 106 may be disposed together with a mobile power bank for extending a usage time of the communication apparatus 106.

The attack apparatus 102 may emit an attack signal, and the wearable apparatus 104 may sense the attack signal emitted by the attack apparatus 102 and transmit an attack message sensed to the communication apparatus 106. The communication apparatus 106 is capable of determining a property of the attack apparatus 102 (e.g., a type of the attack apparatus 102 and a level of an attack power thereof) according to the attack message included in the attack signal, and adjusting a status prompt signal emitted by the wearable apparatus 104 according to the property of the attack apparatus 102, so as to display the status of the wearable apparatus 104. The status prompt signal may include, for example, one of a sound signal and an optical signal, or a combination thereof.

For instance, it is assumed that wearable apparatus 104 is capable of displaying light signals in different colors, and the light signals in different colors each represents a level of a hit point of the player using the wearable apparatus 104 (e.g., the level of the hit point of the player are respectively represented, from higher to lower, by the light signals in colors of blue, green, yellow and red). In case the attack signal received by the wearable apparatus 104 is corresponding to the attack apparatus 102 with the lower attack power, the corresponding hit point to be deducted is less, so that the wearable apparatus 104 may display the light signal representing the higher hit point (e.g., green). Similarly, in case the attack signal received by the wearable apparatus 104 is corresponding to the attack apparatus 102 with higher attack power, the corresponding hit point to be deducted is more, so that the wearable apparatus 104 may display the light signal representing lower hit point (e.g., yellow). In addition, while switching the light signals, the wearable apparatus 104 may also emit the sound signal to inform the player of a remaining hit point, so as to facilitate the player in handling current condition of gameplay.

In addition, in some embodiments, the communication apparatus 106 (e.g., a cell phone) may download an application, and utilize the downloaded application to set the property of the wearable apparatus 104 (e.g., setting a team name or a profession that the wearable apparatus 104 belongs to). A different profession of the wearable apparatus 104 may provide a different defense. The attack apparatus 102 paired with the wearable apparatus 104 may also be decided while deciding the profession of the wearable apparatus 104, and the player using the wearable apparatus 104 is required to use the attack apparatus 102 and equipments which are corresponding to the profession of the wearable apparatus 104. A different profession of the wearable apparatus 104 is corresponding to a different type of the attack apparatus 102, and the different type of the attack apparatus 102 may provide a different attack power. For instance, in case the attack apparatus 102 is the bullet, the different profession of the wearable apparatus 104 may be corresponding to a different type of the bullet, and the different type of the bullet may deal a different damage. Abilities (e.g., the defense of the wearable apparatus 104, the attack power of the attack apparatus 102 and so on) in the property for the different profession may be processed and managed by said application and a remote server, so as to facilitate in gameplay while improving flexibility and strategies in gameplay.

It should be noted that, the communication apparatus 106 may determine the property of the attack apparatus 102 according to the attack message included in the attack signal. When the communication apparatus 106 determines that the attack apparatus 102 is an apparatus paired with the wearable apparatus 104 according to the attack signal, the communication apparatus 106 does not adjust the status prompt signal emitted by the wearable apparatus 104 according to the attack signal, so as to prevent the hit point being reduced by the attack signal emitted by the attack apparatus 102 and received by the wearable apparatus 104 while using the attack apparatus 102 paired with the wearable apparatus 104 worn by the player.

Moreover, in addition to the light signals for representing the hit point, the wearable apparatus 104 may also be disposed with other different light signals for representing the property of the wearable apparatus 104, such as the team name, the profession and so on. Accordingly, other players may quickly identify friend and foe relationships between one another to improve convenience in gameplay and avoid exposing of locations and disputes caused by the player trying to explain his/her identification to the other players.

Furthermore, in addition to setting of the team name and the profession that the wearable apparatus 104 belongs to, the communication apparatus 106 may also display the statuses and the properties of the wearable apparatus 104 and the attack apparatus 102, such as displaying the status (the hit point of the wearable apparatus 104), the team name, the defense, the profession of the player, as well as the type, the damage possibly dealt, a number of remaining bullets and the usage status of the attack apparatus 102. In some embodiments, the communication apparatus 106 may further include a global positioning system function for positioning locations of the player and teammates or even hostile players, so as to improve convenience and fun in gameplay.

It should be noted that, different types of said bullets may be completely the same or different in terms of actual appearance. As along the attack signals emitted by said bullets are different from one another, the wearable apparatus 104 is capable of classifying them as the different type of the bullet. Further, the different type of the bullet may be corresponding to a different projectile launchers (e.g., a toy gun or a firearm, but the invention is not limited thereto). In some embodiment, the projectile launchers may be also be paired with the wearable apparatus 104, namely, the different profession is correspondingly using the different projectile launchers. The projectile launchers may communicate with the communication apparatus 106 (e.g., through bluetooth). When the player gets the projectile launcher which is not corresponding to the wearable apparatus 104 used by the player, the communication apparatus 106 may inform the player that the projectile launcher is not the one to be used by the player through an image signal or the sound signal.

Referring to FIG. 2, FIG. 2 is a schematic view of a game apparatus according to another embodiment of the invention. More specifically, the wearable apparatus 104 of the game apparatus of FIG. 1 may include a sensing unit 202, a communication unit 204, a status prompt unit 206 and a control unit 208 as shown in FIG. 2. The control unit 208 is coupled to the sensing unit 202, the communication unit 204 and the status prompt unit 206. The sensing unit 202 is used for sensing the attack signal emitted by the attack apparatus 102. The communication unit 204 is responsible for a signal transmission between the wearable apparatus 104 and the communication apparatus 106. The communication unit 204 may be, for example, a bluetooth apparatus or other wireless or wired signal transmission apparatuses. The control unit 208 controls the communication unit 204 to transmit the attack signal sensed by the sensing unit 202 to the communication apparatus 106. The communication unit 106 determines the property of the attack apparatus 102 according to the attack signal and transmits a control signal to the communication unit 204 according to the property of the attack apparatus 102 for the control unit 208 to adjust the status prompt signal emitted by the status prompt unit 206 according to the control signal. The status prompt unit 206 may be implemented by devices (e.g., a light-emitting diode or a speaker) for providing one of the optical signal and the sound signal or a combination thereof to be used as the status prompt signal.

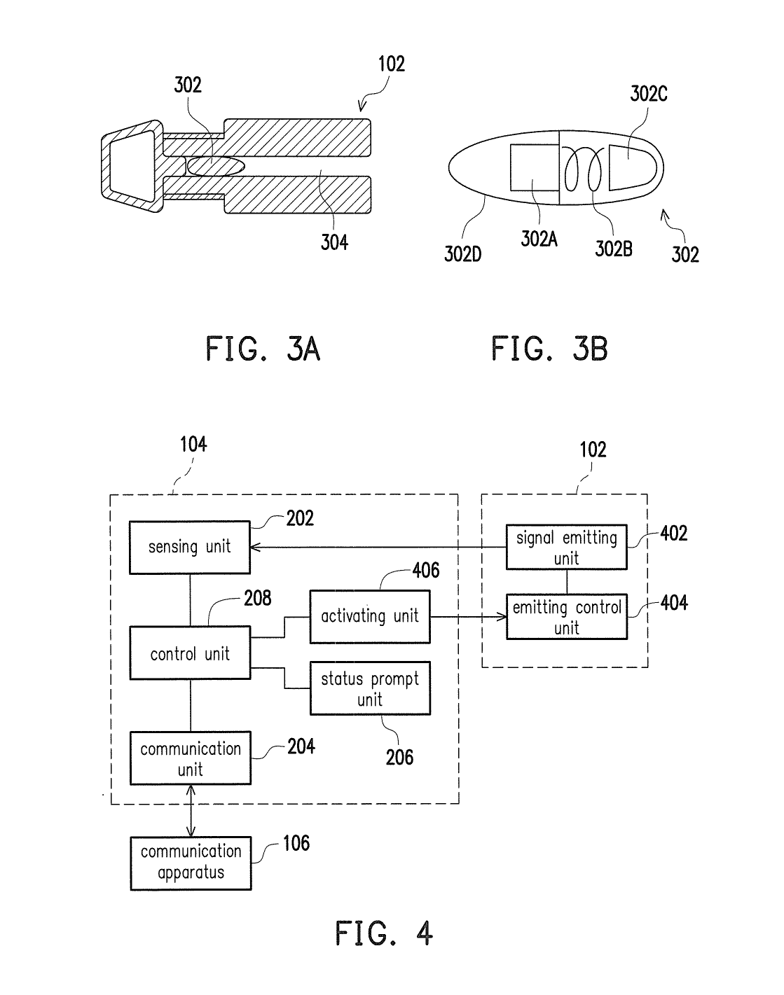

In some embodiments, the attack apparatus 102 may be implemented by an electronic tag, and the sensing unit 202 may be implemented by an electronic tag reader. For instance, referring to FIG. 3A and FIG. 3B, where FIG. 3A is a cross-sectional view of an attack apparatus according to an embodiment of the invention, and FIG. 3B is a schematic view of the electronic tag of the embodiment of FIG. 3A. As shown in FIG. 3A, the attack apparatus 102 of the present embodiment is the bullet having an accommodating space 304 for accommodating an electronic tag 302. The electronic tag 302 in the bullet may include a chip 302A, an elastic object 302B, an antenna 302C and a housing 302D. The elastic object 302B may be implemented by, for example, a plastic spring or a metal spring, but the invention is not limited thereto. A disposing direction of the chip 302A, the elastic object 302B and the antenna 302C in the housing 302D is parallel to a flying direction of the bullet. The elastic object 302B is disposed between the chip 302A and the antenna 302C, and the accommodating space in the housing 302D has a length parallel to the flying direction of the bullet which is longer than a total length of the chip 302A, the elastic object 302B and the antenna 302C. Accordingly, before the bullet is fired, the chip 302A, the elastic object 302B and the antenna 302C are in a state of separating from one another. In the present embodiment, the chip 302A is fixed on a bullet head of the bullet, and the elastic object 302B and the antenna 302C are in a non-fixed state, such that the chip 302A, so that the elastic object 302B and the antenna 302C may still be in the state of separating from one another to reduce chances in damaging the chip 302A due to collision.

After the bullet is fired, when the bullet is slowed down by air resistance or hit on objects in flight, the antenna 302C of the electronic tag 302 in the bullet may be pressed to the elastic object 302B due to inertial effect, such that the antenna 302C and the chip 302A may be in contact to generate an electrical connection thereby allowing the electronic tag 302 to operate its function normally as to be read by the sensing unit 202 of the wearable apparatus 104. When the bullet lands or remains stationary, the elastic object 302B in the bullet may recover the state in which the chip and the antenna are separated, so that the electronic tag 302 cannot operate its function normally for avoiding misjudgment of the wearable apparatus 104 caused by the used bullet to influence gameplay.

Referring to FIG. 4, FIG. 4 is a schematic view of a game apparatus according to another embodiment of the invention. In the present embodiment, the attack apparatus 102 may be, for example, the explosive apparatus (e.g., a simulated mine, a simulated grenade, a simulated time bomb, a simulated remote-controlled bomb, and so on). The attack apparatus 102 may include a signal emitting unit 402 and an emitting control unit 404, and the signal emitting unit 402 is coupled to the emitting control unit 404. On the other hand, the wearable apparatus 104 may further include, as in comparison to the wearable apparatus of FIG. 2, an activating unit 406 coupled to the control unit 208. The emitting control unit 404 is used for controlling the signal emitting unit 402 to emit the attack signal, and timing for the emitting control unit 404 to control the signal emitting unit 402 to emit the attack signal is decided by the activating unit 406. For instance, it is assumed that the attack apparatus 102 is the simulated remote-controlled bomb, and the player may set the attack apparatus 102 on places where the other players may pass by. When there are the other players who enter an attacking range of the attack apparatus 102, the player may issue a detonation command to the control unit 208 through the communication apparatus 106 for the control unit to control the activating unit 406 to emit the activating signal to the emitting control unit 404, so that the signal emitting unit 402 is controlled to emit the attack signal thereby achieving the purpose of attacking the other players. The signal emitting unit 402 and the activating unit 406 may be implemented by, for example, an active electronic tag, and the emitting control unit 404 may be implemented by, for example, the electronic tag reader. However, the invention is not limited thereto. The signal transmission between the attack apparatus 102 and the wearable apparatus 102 may also be completed by other wireless communication technologies.

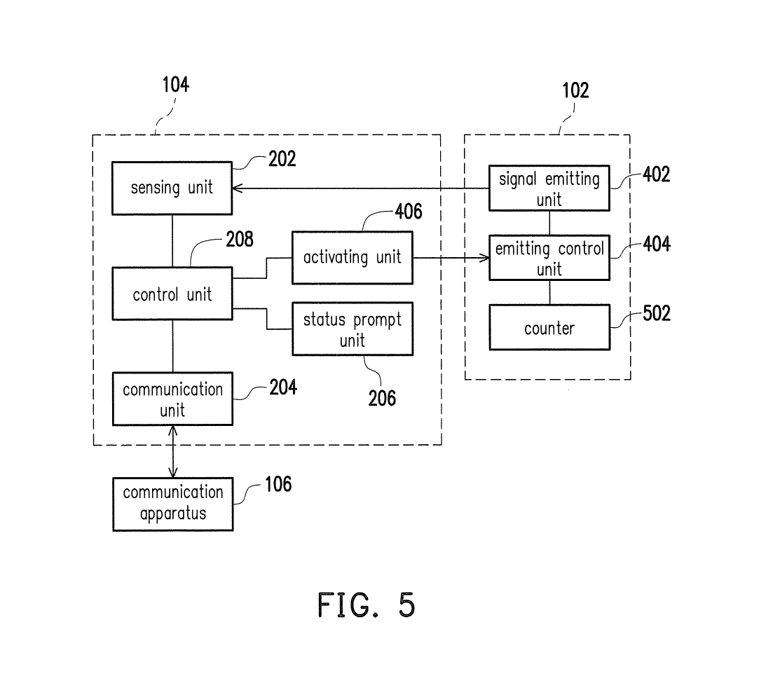

Referring to FIG. 5, FIG. 5 is a schematic view of a game apparatus according to another embodiment of the invention. In the present embodiment, the attack apparatus 102 may be, for example, the simulated time bomb, and buttons and a display apparatus (which are not illustrated) may be disposed on the attack apparatus 102 for setting a countdown time of explosion thereby deciding the timing for the emitting control unit 404 to control the signal emitting unit 402 to emit the attack signal. A counter may be disposed inside the emitting control unit 404, or outside the emitting control unit 404. More specifically, the attack apparatus 102 may further include a counter 502 coupled to the emitting control unit 404 and configured to count time. The emitting control unit 404 may control the signal emitting unit 402 to emit the attack signal only after the activating signal is received for passing a predetermined time, so as to achieve the purpose of using the attack apparatus 102 as the simulated time bomb.

In view of above, the embodiments of FIG. 2 to FIG. 4 further describe details regarding the embodiment of the game apparatus of FIG. 1. Since application scenarios for the attack apparatus 102, the wearable apparatus 104 and the communication apparatus 106 have been described in details by the embodiment of FIG. 1, persons with ordinary skill in the art should be able to infer application scenarios for identical or similar elements in the embodiments of FIG. 2 to FIG. 4 based on teachings of the embodiment of FIG. 1, thus related descriptions thereof are not repeated herein.

In summary, the communication apparatus of the invention may determine the property of the attack apparatus according to the attack signal sensed by the wearable apparatus, and adjust the status prompt signal emitted by the wearable apparatus according to the property of the attack apparatus, and the status prompt signal prompts the status of the wearable apparatus. Based on the status prompt signal emitted by the wearable apparatus, the player may learn the hit points of the enemy players or the teammates by a quick look, so as to improve fairness of gameplay. In some embodiments, the communication apparatus may further set the team name and the profession that the wearable apparatus belongs to and the corresponding attack apparatus while utilizing the global positioning system function for positioning locations of the player and the teammates or even the hostile players, so as to improve variability and fun in gameplay.

What is claimed is:

1. A game apparatus, comprising:
an attack apparatus;
a wearable apparatus sensing an attack signal of the attack apparatus; and
a communication apparatus communicating with the wearable apparatus, determining a property of the attack apparatus according to the attack signal sensed by the wearable apparatus, and adjusting a status prompt signal emitted by the wearable apparatus according to the property of the attack apparatus, wherein the status prompt signal prompts a status of the wearable apparatus.

2. The game apparatus of claim 1, wherein the communication apparatus further displays the status and a property of the wearable apparatus and a status and the property of the attack apparatus.

3. The game apparatus of claim 2, wherein the property of the wearable apparatus comprises a defense of the wearable apparatus, a team name and a profession that the wearable apparatus belongs to; the property of the attack apparatus comprises a type of the attack apparatus and a damage possibly dealt by the attack apparatus; the status of the wearable apparatus comprises a hit point of the wearable apparatus; and the status of the attack apparatus comprises a usage status of the attack apparatus.

4. The game apparatus of claim 3, wherein a different profession of the wearable apparatus is correspondingly paired with a different type of the attack apparatus, the communication apparatus further determines whether the attack apparatus is an apparatus paired with the wearable apparatus according to the attack signal, and the communication apparatus does not adjust the status prompt signal emitted by the wearable apparatus according to the attack apparatus if the attack apparatus is the apparatus paired with the wearable apparatus.

5. The game apparatus of claim 1, wherein the wearable apparatus comprises:
a sensing unit sensing the attack signal;
a communication unit;
a status prompt unit emitting the status prompt signal; and
a control unit coupled to the sensing unit, the communication unit and the status prompt unit, controlling the communication unit to transmit the attack signal sensed by the sensing unit to the communication apparatus, and the communication unit determining the property of the attack apparatus according to the attack signal and transmitting a control signal to the communication unit according to the property of the attack apparatus for the control unit to adjust the status prompt signal emitted by the status prompt unit according to the control signal.

6. The game apparatus of claim 5, wherein the attack apparatus comprises an electronic tag, and the sensing unit comprises an electronic tag reader.

7. The game apparatus of claim 6, wherein the attack apparatus is a bullet having an accommodating space for accommodating the electronic tag, and the electronic tag comprises:
a housing;
a chip;
an elastic object; and
an antenna, and a disposing direction of the chip, the elastic object and the antenna in the housing being parallel to a flying direction of the bullet, wherein the elastic object is disposed between the chip and the antenna, and the accommodating space in the housing has a length parallel to the flying direction of the bullet which is longer than a total length of the chip, the elastic object and the antenna.

8. The game apparatus of claim 5, wherein the attack apparatus further comprises:
a signal emitting unit; and
an emitting control unit coupled to the signal emitting unit, and receiving an activating signal for controlling the signal emitting unit to emit the attack signal.

9. The game apparatus of claim 8, wherein the wearable apparatus further comprises:
an activate unit coupled to the control unit, and emitting the activating signal under control of the control unit.

10. The game apparatus of claim 9, wherein the signal emitting unit and the activating unit are active electronic tags, and the sensing unit and the emitting control unit are electronic tag readers.

11. The game apparatus of claim 8, further comprising:
a counter coupled to the emitting control unit, configured to count time, and the emitting control unit controlling the signal emitting unit to emit the attack signal after the activating signal is received for passing a predetermined time.

12. The game apparatus of claim 1, wherein the status prompt signal comprises one of a sound signal and an optical signal, or a combination thereof.

13. The game apparatus of claim 1, wherein the communication apparatus comprises a smart phone or a tablet computer.

14. The game apparatus of claim 1, wherein the communication apparatus further comprises a global positioning system function for positioning a location of the wearable apparatus or the communication apparatus.
